(19) United States
(12) Patent Application Publication
(10) Pub. No.: US 2006/0176422 A1
(43) Pub. Date: Aug. 10, 2006

(54) Brightness-enhancing integral polarizer and optical film structure and a manufacturing method thereof

(76) Inventors: Yue-Shih Jeng, Miao Li Hsien (TW); Yuh-Shyang Chen, Taipei City (TW); Wei-Chih Liu, Tai Chung City (TW); Tsung-Hsiung Wang, Ta Li City (TW); Yu-Hsun Wu, Chung Li City (TW); Wei-Yi Chien, Chi Lung City (TW)

Correspondence Address: RABIN & BERDO, P.C., Suite 500, 1101 14 Street, N.W., Washington, DC, 20005, US

(21) Appl. No.: 11/159,316

(22) Filed: Jun. 23, 2005

(30) Foreign Application Priority Data
Feb. 4, 2005 (TW) 94103676

(51) Int. Cl. G02F 1/1335

(52) U.S. Cl. 349/96

(57) ABSTRACT

A brightness-enhancing integral polarizer and optical film structure and manufacture are described. The brightness-enhancing integral polarizer and optical film have an absorptive polarizer and a reflective polarizer. The reflective polarizer generates a reflective light source effect, and uses a nonlinear optic design to coat a brightness-enhancing integral polarizer and optical film with a different dye on at least one substrate and produce the effects of brightness enhancement, high polarization, high transmittance, wide viewing angle and high contrast for the brightness-enhancing integral polarizer and optical film structure and manufacturing method.

### BACKGROUND OF THE INVENTION

1. Field of the Invention

The present invention relates to a brightness-enhancing integral polarizer and optical film structure and a manufacturing method for the same, and more particularly to a brightness-enhancing integral polarizer and optical film structure, and a manufacturing method for the same, that use a non-linear optical design to coat a brightness-enhancing integral polarizer and optical film with a different dye onto at least one substrate. The brightness-enhancing integral polarizer and optical film include two kinds of polarizers, an absorptive polarizer and a reflective polarizer, and the reflective polarizer provides a reflective light source and concurrently features enhanced reflective brightness, high degree of polarization, high transmittance, wide viewing angle and high contrast.

2. Description of Related Art

A liquid crystal display mainly uses a linear polarization produced by two polarizers to achieve its display effect and a backlight module as its main light source. The light produced by the backlight module passes through a first polarizer to produce a linear polarization, and then a second polarizer produces a change of brightness according to twisted nematic liquid crystal molecules to provide the display effect for a viewer's eyes.

A light source usually can maintain less than 5% of its brightness perceived by a viewer after the light passes through several layers of materials and goes through the processes of reflections, refractions or absorptions. The absorption and light transmission of a dichroic polarizer in a display are the main factors that affect brightness, and thus increasing the intensity of a light source and its light transmittance level is a main issue for displays.

At present, there are two main methods for increasing the overall light transmittance level: (1) by increasing the transmitting effect of an incident light; and (2) by increasing the light intensity of a backlight module. The first method is to improve the transmittance of a polarizer, or change the polarization mode of an incident light before the incident light enters the polarizer, so that the polarization mode of the incident light is parallel to the polarization of the polarizer, thus enhancing the transmissive effect of the incident light. At present, the transmittance of the current iodine polarizers is up to 44% to 46%, and has approached a level that makes a further improvement of the light transmittance level difficult. The way of changing the polarization mode of an incident light to make the polarization parallel to the polarization of the polarizer and achieve a high light transmittance goes with an enhanced brightness film produced by a DBEF (by the 3M Company) and the reflective polarizer of a cholesterol liquid crystal. The second method is to increase the intensity of the incident light of a backlight source or achieve a 100% polarized light transmitting effect by a direct polarization of the backlight source. In summation of the description above, the contrast, viewing angle and light transmittance level of the display are determined by the polarizer. Increasing the light transmittance level of polarizers is an important development trend for polarizers in the future.

The present major polarizer is the O-type iodine polarizer. Its main advantages include (1) a high degree of polarization (99.9%); (2) a high light transmittance level (44%-46%), and its main disadvantages include (1) a large viewing angle that gives a strong leakage of light, thus requiring a wide viewing angle film to achieve a high contrast effect; (2) poor climate resistance; (3) low mechanical characteristic, thus requiring a protective film to enhance the mechanical characteristic thereof, and (4) a requirement of being used and attached on the exterior of the display. At present, an E-type liquid crystal polarizer is the latest polarizer, and the body of the polarizer primarily adopts absorptive disc-shaped liquid crystals, so that if light passes through the disk-shaped liquid crystal, the O-type polarized light will be absorbed and the E-type polarized light passes through, so as to achieve a linear polarization effect. The best optical effect for the polarizer of this kind has a polarization level of approximately 95% and a light transmittance level of approximately 40%-44%. The E-type polarizer has the disadvantages of (1) having insufficient polarization level and light transmittance level for the TFT-LCD and (2) having a small viewing angle that will cause a light leak. On the other hand, the E-type polarizer has the advantages of (1) providing a lightweight and thin polarizer (approximately 0.3-0.8 μm) and (2) being produced in the display cell (refer to FIG. 1 for the comparison table of the characteristics of the O-type polarizer and the E-type polarizer).

Another research area for a coated polarizer is the dye series polarizer. A polarizer of this type primarily absorbs dyes as its carriers. The parameters affecting the absorbability of a polarizer includes (1) the coefficient of absorption of dye molecules, (2) the dye concentration, and (3) the thickness of the polarizer. The main advantages of the dye series polarizer include (1) stronger climate resistance, (2) more choices for the coating method, including spin coating, die coating and dip coating, and (3) being manufactured in a display cell. The dye series polarizer has the disadvantages of (1) having difficulties of obtaining a dye with a high absorption level, (2) a high level of polarization requires a dye with a high concentration, and thus results in high costs, and (3) a thick film (approximately 3 μm) causes a decrease of light transmittance and thus limits the applications of the dye series polarizer.

An enhanced brightness film is mainly divided into a cholesterol liquid crystal reflective-type polarizer and a reflective-type DBEF multilayer film. The main principle of the optical device of a cholesterol liquid crystal reflective polarizer adopts the separation characteristics of the left-hand rotated and the right-hand rotated cholesterol polarized lights to separate a non-polarized white incident light into left-rotated and right-rotated polarized lights. The circularly polarized light with an opposite optical rotation can pass through, and the circularly polarized light in the same optical rotation is reflected. The passing circularly polarized light is reflected for a second time to increase the light transmittance level. To cope with a ¼ wavelength delay film, the passing circularly polarized light is converted into a linear polarized light and then enters the polarizer. As a result, the light source is fully converted into a polarization mode for passing all polarized lights through the polarizer to achieve the brightness enhancement effect. The principle of a dual brightness enhancement film (DBEF) mainly uses two different materials with different refraction indexes to form a multilayer film. A white light passes through the multilayer film to divide the non-polarized white light into a light P parallel to an incident surface and a light S perpendicular to the incident surface. After the white light passes through the dual brightness enhancement film, the wave P penetrates and the wave S is reflected. The wave S reflected by an interface penetrates after being converted into the wave P, and the final objective is to pass a plurality of light sources through the polarizer, so as to achieve the brightness enhancement effect.

Referring to FIG. 2, a comparison table of the characteristics of the reflective dual brightness enhancement film and the cholesterol liquid crystal reflective polarizer is shown. In FIG. 2, the present enhancement film has a brightness enhancement of approximately 60%. In an overall analysis of the light transmission effect of a display, a non-polarized light source passing through a brightness enhancement film is converted into a polarized light, and then passed through the polarizer. The overall optical analysis is considered multilayer polarizer analysis. From multilayer polarizer optical analysis, a polarizer has two or more layers, without being stacked optically with each other. Although such arrangement can increase the polarization and contrast to a certain extent, the light transmittance level is reduced greatly. For example, the light transmitting effect of the DBEF is accompanied with the iodine polarizer (polarization =99.8% and light transmittance level =44%) that passes a light through a light-enhancing film and then a polarizer, without taking the second light transmission effect of the reflective light into consideration, temporarily. The light transmittance level of the DBEF is approximately 44%. Combined with the light transmittance level of 44%-46% of the iodine polarizer, the overall light transmittance level is lowered to about 40%-41%.

As to the polarization, the iodine polarizer has a polarization of approximately 99.5%, and thus the contribution of the brightness-enhancing film to the overall polarization is negligible. In summation of the description above, the brightness enhancement effect produced by the brightness-enhancing film accompanied with the polarizer is used to lower the light transmittance level first, and then the second light transmittance level of the reflective light is used again to increase the light transmittance level. Therefore, the multilayer film does not have a good optical effect, but has a large loss of light transmittance level. Even if a light-enhancing film is added, the whole light enhancement effect of the light-enhancing film cannot be shown. If a cell is manufactured in the future, then a common light-enhancing film sold in the market usually comes with a thickness exceeding 100 mm (over 100 mm for the DBEF), and such thickness will cause a shift of drive voltage in the cell that makes the manufacture difficult. Thus, only external cells can be manufactured to go with the common polarizer sold in the market.

At present, the mainstream of iodine polarizers as disclosed by U.S. Pat. No. 4,591,512 entitled “Method of making light polarizer” uses a polyvinyl alcohol (PVA) for its substrate. After immersing a uniaxially stretched film of the PVA in an iodine solution to produce a light polarizer, qualities such as the mechanical characteristic, climate resistance, and heat resistance of the film layer are poor. Besides the body of the iodine polarizer, the upper and lower surfaces require a TAC film as a protective film. Therefore, the thickness of the current iodine polarizers is approximately 200 μm. In the E-type polarizers as disclosed in U.S. Pat. Nos. 6,583,284, 6,563,640, 6,174,394, 6,049,428 and 5,739,296, the polarizer is produced by a coating process to coat supermolecules with an absorption effect on the surface of the substrate, so as to complete the manufacture of the E-type polarizer. After a light passes through the polarizer, the polarization status is exactly opposite that of the traditional 0-type polarizers, which is known as E-type polarization. In another method of coating the O-type polarizer, a dye is coated onto the surface of the substrate to produce a polarizer. U.S. Pat. Nos. 5,812,264, 6,007,745, 5,601,884 and 5,743,980 are patents related to the dye coating of polarizers. The main principle of the light-enhancing film is to divide a non-polarized visible light into two perpendicular polarized lights, such that a polarized light is passed, and another perpendicular polarized light is reflected and converted into a parallel polarization, and then passed for a second time.

The prior art reflective type polarized light-enhancing films are disclosed in U.S. Pat. Nos. 5,828,488, 6,101,032 and 6,124,971. The cholesterol liquid crystal reflective-type polarizer is disclosed in U.S. Pat. Nos. 5,999,243, 6,016,177 and 6,025,958, and the fully coated cholesterol liquid crystal reflective brightness-enhancing device is disclosed in U.S. patent application Ser. No. 20040130672_A1, and the objective of this patent is change the color shift only.

In summation of the description above, the polarizer for producing a polarization in the present LCDs does not itself come with a brightness enhancement effect; rather, the brightness enhancement effect is provided by the brightness-enhancing film. Most of the systems adopt a brightness-enhancing film attached with a polarizer, but the systems do not combine with a polarizer to produce the overall performance.

### SUMMARY OF THE INVENTION

In view of the foregoing shortcomings of the prior art polarizers, the present invention provides a brightness-enhancing integral polarizer and optical film structure, and a manufacturing method for the same, to overcome the foregoing shortcomings.

Therefore, it is a primary objective of the present invention to provide a brightness-enhancing integral polarizer and optical film structure, and a manufacturing method for the same, that primarily adopt a system assembly model to overcome the overall poor match of optical effect of the traditional polarizer and brightness-enhancing film, causing an overall decrease of the light transmittance and having its polarization contributed by the polarizer only. The present invention rearranges the polarization and light transmittance level of different films to produce an overall polarization and light transmittance level higher than those of the polarizer accompanied with the brightness-enhancing film. The invention also has the effect of a reflective light, and thus the brightness-enhancing integral polarizer together with the optical film in accordance with the present invention can fully obtain a light transmittance effect for the first and second times, without incurring an optical loss.

To achieve the foregoing objective, the present invention provides a method for manufacturing a brightness-enhancing integral polarizer and optical film structure, which is used as a polarizer for displays, a brightness-enhancing film, a wide viewing angle film, or a general optical film. The manufacturing method comprises the steps of providing at least one substrate and coating at least one layer of a brightness-enhancing integral polarizer and optical film made of a material different from that of the substrate onto the substrate. Such material includes two portions, a reflective type polarized brightness-enhancing film and an absorptive polarizer.

The present invention also provides a brightness-enhancing integral polarizer and optical film structure, which is coated with at least one layer of material different from that of the brightness-enhancing integral polarizer and optical film. Such material includes two portions, a reflective type polarized brightness-enhancing film and an absorptive polarizer.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a comparison table of the characteristics of a prior art O-type polarizer and a prior art E-type polarizer;

FIG. 2 is a comparison table of the characteristics of a prior art reflective type polarized brightness-enhancing film and a prior art cholesterol reflective polarizer;

FIG. 3A is a schematic view of a brightness-enhancing integral polarizer and optical film in accordance with the present invention;

FIGS. 3B and 3C are schematic views of a brightness-enhancing integral polarizer and optical film structure manufactured by coating a different material onto a single substrate in accordance with a preferred embodiment of the present invention;

FIG. 4 is a schematic view of a brightness-enhancing integral polarizer and optical film structure in accordance with the present invention; and

FIGS. 5A to 5E are schematic views of a brightness-enhancing integral polarizer and optical film structure, including a conductive layer therein in accordance with the present invention.

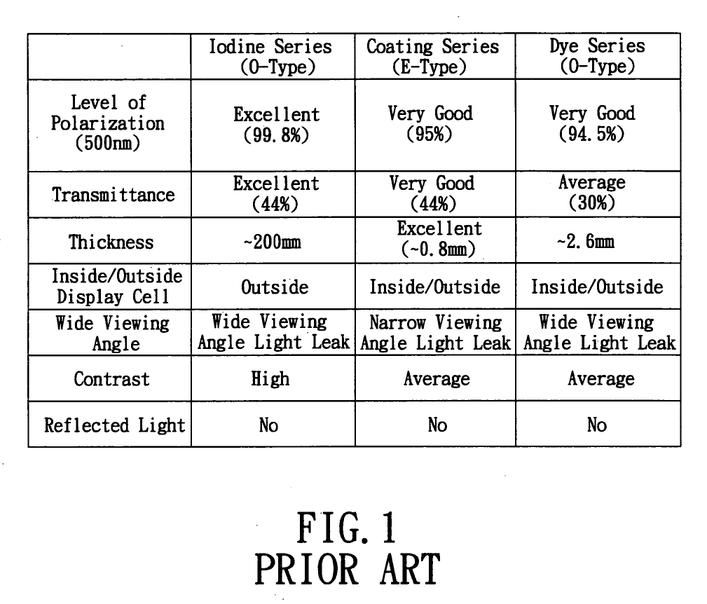

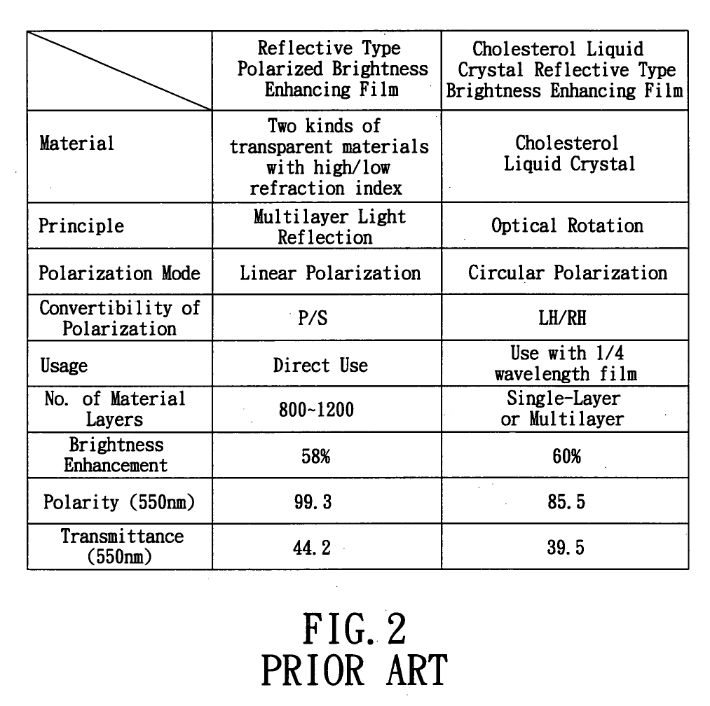

### DETAILED DESCRIPTION OF THE PREFERRED EMBODIMENTS

The above and other objects, features, and advantages of the present invention will become apparent from the following detailed description taken with the accompanying drawings. However, the drawings are provided for reference and illustration, and are not intended to limit the present invention.

If light passes through two polarizers stacked with each other, the total thickness of the polarizers is greater than the thickness of a single polarizer, thus increasing the light transmitting thickness. Although such an arrangement increases absorbability and polarization, it suffers a significant loss of light transmission. In addition to the basic film problems, the two stacked polarizers also have an optic axis alignment problem. If the polarized light produced by a first polarizer enters a second polarizer, some portion of the light intensity is absorbed due to the deviation angle of the optic axis alignment. The light transmission level will thus drop. Although the two combined polarizers can increase the degree of polarization, the precious light transmission level is sacrificed as a tradeoff, and such a tradeoff is undoubtedly a major disadvantage for the display industry.

The present invention uses a non-linear nonlinear optical design to carry out a system model integration and combines two low-efficiency polarizers into a polarizer of high polarization and high transmittance. The invention carries out an optical system integration for two different polarizers to produce a brightness-enhancing integral polarizer and optical film. The levels of polarization and transmittance of the brightness-enhancing integral polarizer and optical film are rearranged for each film, and thus the overall level of polarization and light transmittance of the polarizer are determined by the entire film. Although the level of polarization and transmittance of the entire film is a constant, the combination of the films may vary, and thus may be rearranged and combined according to different environmental conditions and different compositions of materials. Since the level of polarization and light transmittance varies in different films, the stacked film will not lose the required light transmittance, but it will enhance the degree of polarization.

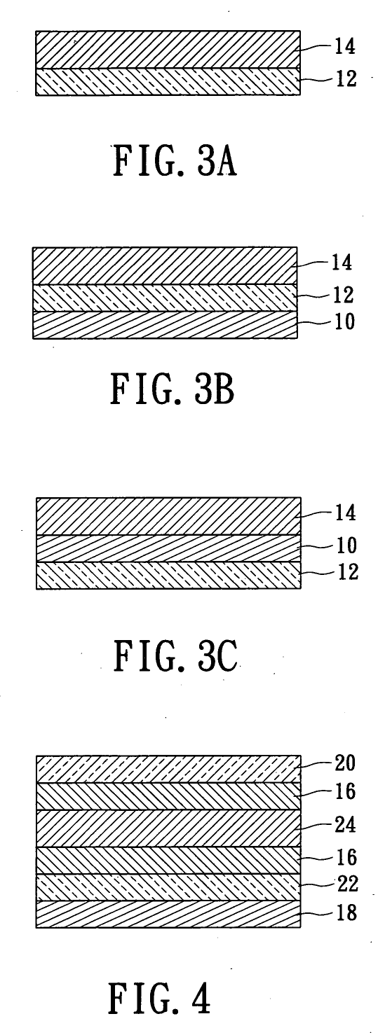

Reference is made to FIG. 3A for a schematic view of a brightness-enhancing integral polarizer and optical film structure in accordance with the present invention. The brightness-enhancing integral polarizer and optical film structure are coated with at least one layer of a different material, and the brightness-enhancing integral polarizer and optical film made of a different material includes two portions, a reflective type polarized brightness-enhancing film 12 and an absorptive polarizer 14.

Reference is made to FIGS. 3B and 3C for schematic views of brightness-enhancing integral polarizer and optical film manufactured by coating a different material onto a single substrate in accordance with a preferred embodiment of the present invention. In FIG. 3B, the coated brightness-enhancing integral polarizer and optical film are used as a polarizer for displays, a brightness-enhancing film, a wide viewing angle film, or a general optical film. The structure comprises at least one substrate 10, and a brightness-enhancing integral polarizer and optical film coated with a different material and disposed on any side of the substrate 10. The brightness-enhancing integral polarizer and optical film made of a different material includes two portions, a reflective polarizer 12 and an absorptive polarizer 14.

As illustrated in the figure, two brightness-enhancing integral polarizers and optical films are stacked with each other and constructed on the same side of a substrate 10. The substrate 10 is a transmissive substrate or a non-transmissive substrate. The brightness-enhancing integral polarizer and optical film made of a different material combines a reflective polarizer and an absorptive polarizer. The design of the brightness-enhancing integral polarizer and optical film made of a different material adopts the combination of several dye brightness-enhancing polarizers and optical films. The types of these polarizers include the O-type, E-type, P-type, S-type, right-handed rotary type, left-handed rotary type, and their combinations.

If the brightness-enhancing integral polarizer and optical film made of a different material are produced outside a display cell, the absorptive polarizer is a dye polarizer or an E-type polarizer, and the reflective polarizer is a reflective type polarized brightness-enhancing film or a cholesterol liquid crystal brightness-enhancing film.

If the reflective polarizer is produced outside a display cell, the reflective polarizer can be a reflective type polarized brightness-enhancing film or a cholesterol liquid crystal reflective-type polarizer brightness-enhancing film. The absorptive polarizer can be constructed inside or outside a display cell. If the absorptive polarizer is an E-type polarizer and the reflective polarizer is a cholesterol liquid crystal reflective-type polarizer brightness-enhancing film, then a λ/4 wavelength sheet is installed between the E-type polarizer and a cholesterol liquid crystal layer. If the absorptive polarizer is an E-type polarizer and the reflective polarizer is a cholesterol liquid crystal reflective-type polarizer brightness-enhancing film, then the degree of polarization of the brightness-enhancing integral polarizer and optical film is over 70% and the light transmittance is over 40%. If the absorptive polarizer is constructed outside the display cell, then the reflective polarizer will be attached. The absorptive polarizer is coated onto the reflective polarizer first and then attached onto the display cell.

Unlike the foregoing coating method, the reflective polarizer and the absorptive polarizer as shown in FIGS. 3C and 3D are coated respectively on both sides of a substrate 10. However, the brightness-enhancing integral polarizer and optical film structure disposed on the single substrate adopt the coating method for different combinations. For example, a stacked structure is produced on the single substrate, or the single substrate is coated with any combination of the reflective-polarizer and absorptive polarizer, which will not be described in detail here.

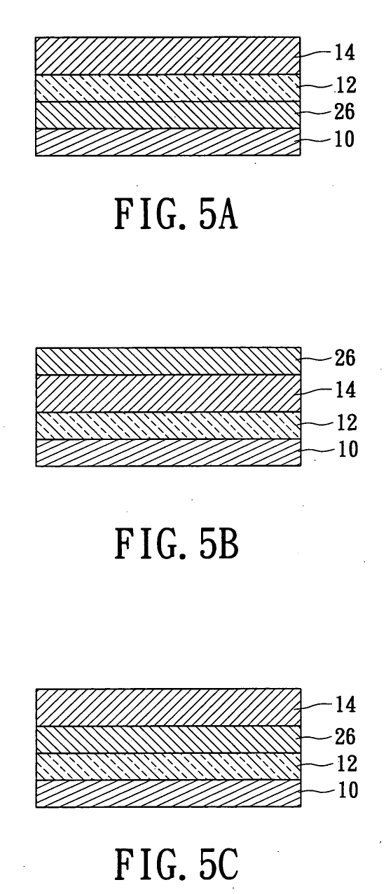

Reference is made to FIG. 4 for a display unit employing the brightness-enhancing integral polarizer and optical film structure in accordance with a preferred embodiment of the present invention. The brightness-enhancing integral polarizer and optical film are used as a polarizer of displays, a brightness-enhancing film, a wide viewing angle film or a general optical film, and the brightness-enhancing integral polarizer and optical film structure are accompanied with the coating method for different combinations. The structure comprises an upper substrate 20 and a lower substrate 22. The upper substrate 20 and the lower substrate 22 are permissive substrates or non-permissive substrates. At least one brightness-enhancing integral polarizer and optical film 16 made of a different material are constructed on any side of the upper substrate 20 or the lower substrate 22. The brightness-enhancing integral polarizer and optical film with a different material include two portions, a reflective polarizer 12 and an absorptive polarizer 14. If the brightness-enhancing integral polarizer and optical film are constructed outside a display cell, then the absorptive polarizer is a dye polarizer or an E-type polarizer, and the reflective polarizer is a reflective type polarized brightness-enhancing film 18 or a cholesterol liquid crystal reflective-type polarizer brightness-enhancing film. The reflective polarizer can be constructed inside or outside a display cell. If the reflective polarizer is constructed outside the display cell, the reflective polarizer is a reflective type polarized brightness-enhancing film or a cholesterol liquid crystal reflective-type polarizer brightness-enhancing film. The absorptive polarizer can be constructed inside or outside a display cell. If the absorptive polarizer is constructed outside the display cell, it is attached to the reflective polarizer. The absorptive polarizer is coated onto the reflective polarizer first and then attached onto the display cell. A plurality of display fluid media 24 is filled between the upper substrate and the lower substrate. The display fluid can be a liquid crystal, an electrophoretic substance, a self-luminous object, or any other fluid medium that can be displayed easily.

If the brightness-enhancing integral polarizer and optical film is constructed outside a display cell, the absorptive polarizer is a dye polarizer or an E-type polarizer, and the reflective polarizer is a reflective type polarized brightness-enhancing film or a cholesterol liquid crystal reflective-type polarizer brightness-enhancing film. If the absorptive polarizer is an E-type polarizer and the reflective polarizer is a cholesterol liquid crystal reflective-type polarizer brightness-enhancing film, then a λ/4 wavelength sheet is installed between the E-type polarizer and a cholesterol liquid crystal layer. If the absorptive polarizer is an E-type polarizer and the reflective polarizer is a cholesterol liquid crystal reflective-type polarizer brightness-enhancing film, then the degree of the polarization brightness-enhancing integral polarizer and optical film is over 70% and the light transmittance is over 40%.

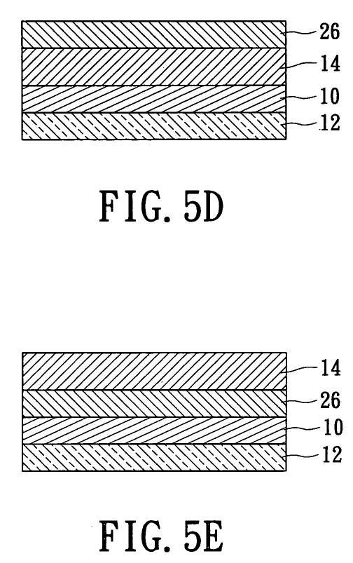

Reference is made to FIGS. 5A to 5E for the schematic views of a brightness-enhancing integral polarizer and optical film structure, including a conductive layer therein in accordance with the present invention. The brightness-enhancing integral polarizer and optical film structure comprises a substrate 10, a reflective polarizer 12, an absorptive polarizer 14, and a conductive layer 26. The conductive layer is constructed on the substrate 10, the absorptive polarizer or the reflective polarizer during a manufacturing process.

The present invention also provides a method for manufacturing brightness-enhancing integral polarizer and optical film used as a polarizer of displays, a brightness-enhancing film, a wide viewing angle film or a general polarizer/optical film. The brightness-enhancing integral polarizer and optical film adopt an optical design of wide viewing angle, thin film, high contrast, high degree of polarization and high light transmittance, and the brightness-enhancing integral polarizer and optical film further comprise at least one substrate made of a transmissive material, a non-transmissive material, or polymers. The brightness-enhancing integral polarizer and optical film have at least one layer of a different material coated onto the substrate and include two portions, a reflective polarizer 12 and an absorptive polarizer 14.

The coating method can be a slot-die coating, an extrusion coating, a Mayer rod coating or a blade coating. The brightness-enhancing integral polarizer and optical film adopt a coating method to be coated onto a thin film transistor inside a display. If the brightness-enhancing integral polarizer and optical film is constructed outside a display cell, then the absorptive polarizer is a dye polarizer or an E-type polarizer and the reflective polarizer is a reflective type polarized brightness-enhancing film or a cholesterol liquid crystal reflective-type polarizer brightness-enhancing film. The reflective polarizer can be constructed inside or outside a display cell. If the reflective polarizer is constructed outside the display cell, then the reflective polarizer is a reflective type polarized brightness-enhancing film or a cholesterol liquid crystal reflective-type polarizer brightness-enhancing film. The absorptive polarizer can be constructed inside or outside a display cell. If the absorptive polarizer is constructed outside the display cell, then the reflective polarizer is attached to a reflective type polarized brightness-enhancing film or a cholesterol liquid crystal reflective-type polarizer brightness-enhancing film. The absorptive polarizer is coated onto the reflective polarizer first and then attached to the display cell (which is attached to the reflective type polarized brightness-enhancing film or the cholesterol liquid crystal reflective-type polarizer brightness-enhancing film).

Unlike the prior arts, the present invention has the following technical characteristics: (1) The present invention employs a full coating method or a half-coating half-attaching method, and the whole polarizer includes two portions, a reflective polarizer and an absorptive polarizer, and both the reflective and absorptive polarizers have contributions to the overall degree of polarization and light transmittance. (2) The present invention designs its polarization and light transmittance such that the combination of the polarizer and the brightness-enhancing film will not just improve the polarization while losing light transmittance. (3) The present invention integrates the polarizers while maintaining the advantages of high polarization, high light transmission, and a wide viewing angle effect. The brightness-enhancing integral polarizer and optical film of the invention primarily adopts a system assembly model to overcome the overall poor match of optical effect of the traditional polarizer and brightness-enhancing film, causing an overall decrease of the light transmittance and having its polarization contributed by the polarizer, only. The present invention rearranges the polarization and light transmittance level of different films to produce high polarization and light transmittance levels accompanied with a brightness enhancement effect. The invention also has the effect of a reflective light, and thus the brightness-enhancing integral polarizer together with the optical film in accordance with the present invention can fully obtain a light transmitting effect for the first and second times without suffering an optical loss.

Overall speaking, the brightness-enhancing integral polarizer and optical film of the present invention includes a reflective polarizer and an absorptive polarizer, in which the reflective polarizer can produce a reflective light source effect. Therefore, the brightness-enhancing integral polarizer and optical film will improve the polarization and light transmittance while having the reflective brightness enhancement effect. The overall transmittance will not drop due to the multiple of films. Compared with the similar brightness-enhancing intensity provided by the brightness-enhancing film, the brightness-enhancing integral polarizer and optical film will produce a better light transmitting effect.

The brightness-enhancing integral polarizer and optical film of the invention shows the required polarization and light transmission by means of a non-linear optical design to rearrange each film, and thus the overall polarization and light transmittance of the brightness-enhancing integral polarizer and optical film are actually determined by the entire film. In addition, although the polarization and light transmittance of the entire film are designed to be constant, there are a variety of combinations for the films and thus can be adjusted according to different environmental conditions and composition of materials. Since the degree of polarization and light transmittance of the brightness-enhancing integral polarizer and optical film are scattered and combined according to the non-linear optical design, the films are stacked with each other. Such arrangement not only prevents a loss of light transmittance, but also improves the overall polarization.

The brightness-enhancing integral polarizer and optical film of the invention comes with a good reflectivity and features a better reflective brightness enhancement effect than that of general iodine polarizers. With the same or better degree of polarization as general iodine polarizers, the light transmittance for both narrow viewing angle range and wide viewing angle range is higher than that of the iodine polarizer. Therefore, the brightness-enhancing integral polarizer and optical film of the invention concurrently has the inflective brightness enhancement and the wide viewing angle features.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing brightness-enhancing integral polarizer and optical film, comprising the steps of:
providing at least one substrate; and
coating at least one layer of a brightness-enhancing integral polarizer and optical film made of a material different from a material of said substrate onto said substrate, wherein said material comprises two portions, one being a reflective type polarized brightness-enhancing film and another being an absorptive polarizer.

2. The method for manufacturing brightness-enhancing integral polarizer and optical film of claim 1, wherein said substrate is made of a transmissive material or a non-transmissive material.

3. The method for manufacturing brightness-enhancing integral polarizer and optical film of claim 1, wherein said substrate is comprised of polymers.

4. The method for manufacturing brightness-enhancing integral polarizer and optical film of claim 1, wherein said coating is a slot-die coating, an extrusion coating, a Mayor rod coating, or a blade coating.

5. The method for manufacturing brightness-enhancing integral polarizer and optical film of claim 1, wherein if said brightness-enhancing integral polarizer and optical film is constructed outside a display cell, said reflective type polarized brightness-enhancing film is a dye series polarizer or an E-type polarizer.

6. The method for manufacturing brightness-enhancing integral polarizer and optical film of claim 1, wherein said reflective type polarized brightness-enhancing film is constructed inside or outside said display cell.

7. The method for manufacturing brightness-enhancing integral polarizer and optical film of claim 1, wherein said absorptive polarizer is constructed inside or outside said display cell.

8. The method for manufacturing brightness-enhancing integral polarizer and optical film of claim 7, wherein said absorptive polarizer is attached to said reflective type polarized brightness-enhancing film when being constructed outside said display cell.

9. The method for manufacturing brightness-enhancing integral polarizer and optical film of claim 7, wherein said absorptive polarizer is coated onto said reflective type polarized brightness-enhancing film first and then attached to said display cell.

10. The method for manufacturing brightness-enhancing integral polarizer and optical film of claim 1, wherein said brightness-enhancing integral polarizer and optical film is used as a polarizer of a display, a brightness-enhancing film, a wide viewing angle film or a general optical film.

11. A method for manufacturing brightness-enhancing integral polarizer and optical film, comprising the steps of:
providing at least one substrate; and
coating at least one layer of a brightness-enhancing integral polarizer and optical film made of a material different from a material of said substrate onto said substrate, wherein said material comprises two portions, one being a cholesterol liquid crystal reflective-type polarizer polarized brightness-enhancing film and another being an absorptive polarizer.

12. The method for manufacturing brightness-enhancing integral polarizer and optical film of claim 11, wherein said substrate is made of a transmissive material or a non-transmissive material.

13. The method for manufacturing brightness-enhancing integral polarizer and optical film of claim 11, wherein said substrate is comprised of polymers.

14. The method for manufacturing brightness-enhancing integral polarizer and optical film of claim 11, wherein said coating is a slot-die coating, an extrusion coating, a Mayor rod coating, or a blade coating.

15. The method for manufacturing brightness-enhancing integral polarizer and optical film of claim 11, wherein if said brightness-enhancing integral polarizer and optical film is constructed outside a display cell, said reflective type polarized brightness-enhancing film is a dye series polarizer.

16. The method for manufacturing brightness-enhancing integral polarizer and optical film of claim 11, wherein said cholesterol liquid crystal reflective-type polarizer brightness-enhancing film is constructed inside or outside said display cell.

17. The method for manufacturing brightness-enhancing integral polarizer and optical film of claim 11, wherein said absorptive polarizer is constructed inside or outside said display cell.

18. The method for manufacturing brightness-enhancing integral polarizer and optical film of claim 17, wherein if said absorptive polarizer is constructed outside said display cell, said absorptive polarizer is attached to said cholesterol liquid crystal reflective-type polarizer brightness-enhancing film.

19. The method for manufacturing brightness-enhancing integral polarizer and optical film of claim 17, wherein said absorptive polarizer is attached to said cholesterol liquid crystal reflective-type polarizer brightness-enhancing film first and then attached to said display cell.

20. The method for manufacturing brightness-enhancing integral polarizer and optical film of claim 11, wherein said brightness-enhancing integral polarizer and optical film is used as a polarizer of a display, a brightness-enhancing film, a wide viewing angle film or a general optical film.

21. A method for manufacturing brightness-enhancing integral polarizer and optical film, comprising the steps of:
providing at least one substrate; and
coating at least one layer of a brightness-enhancing integral polarizer and optical film made of a material different from a material of said substrate onto said substrate, wherein said material comprises two portions, one being a cholesterol liquid crystal reflective-type polarizer polarized brightness-enhancing film and another being an E-type polarizer.

22. The method for manufacturing brightness-enhancing integral polarizer and optical film of claim 21, wherein said substrate is made of a transmissive material or a non-transmissive material.

23. The method for manufacturing brightness-enhancing integral polarizer and optical film of claim 21, wherein said substrate is comprised of polymers.

24. The method for manufacturing brightness-enhancing integral polarizer and optical film of claim 21, wherein said coating is a slot-die coating, an extrusion coating, a Mayor rod coating, or a blade coating.

25. The method for manufacturing brightness-enhancing integral polarizer and optical film of claim 21, wherein said cholesterol crystal liquid reflective type polarized brightness-enhancing film is constructed inside or outside a display cell.

26. The method for manufacturing brightness-enhancing integral polarizer and optical film of claim 21, wherein said E-type polarizer is constructed inside or outside a display cell.

27. The method for manufacturing brightness-enhancing integral polarizer and optical film of claim 21, further installs a λ/4 wavelength sheet between said E-type polarizer and a cholesterol liquid crystal layer.

28. The method for manufacturing brightness-enhancing integral polarizer and optical film of claim 27, wherein said E-type polarizer and λ/4 wavelength sheet have optical axes parallel with each other.

29. The method for manufacturing brightness-enhancing integral polarizer and optical film of claim 21, wherein if said E-type polarizer is constructed outside said display cell, said E-type polarizer is attached to said cholesterol liquid crystal reflective-type polarizer brightness-enhancing film.

30. The method for manufacturing brightness-enhancing integral polarizer and optical film of claim 21, wherein said E-type polarizer is attached to said cholesterol liquid crystal reflective-type polarizer brightness-enhancing film first and then attached to said display cell.

31. The method for manufacturing brightness-enhancing integral polarizer and optical film of claim 21, wherein said brightness-enhancing integral polarizer and optical film has a polarization of over 70% and a light transmission level of over 40%.

32. The method for manufacturing brightness-enhancing integral polarizer and optical film of claim 21, wherein said brightness-enhancing integral polarizer and optical film is used as a polarizer of a display, a brightness-enhancing film, a wide viewing angle film or a general optical film.

33. A brightness-enhancing integral polarizer and optical film structure, being coated with at least one material, and said material comprising two portions, one being a reflective type polarized brightness-enhancing film and another being an absorptive polarizer.

34. A brightness-enhancing integral polarizer and optical film structure, comprising:
at least one substrate;
at least one layer of a material, being different from a material of said substrate and disposed on a side of said substrate, and said material including two portions, one being a reflective type polarized brightness-enhancing film and another being an absorptive polarizer.

35. The brightness-enhancing integral polarizer and optical film structure of claim 34, wherein said substrate is made of a transmissive material or a non-transmissive material.

36. The method for manufacturing brightness-enhancing integral polarizer and optical film structure of claim 34, wherein if said brightness-enhancing integral polarizer and optical film is constructed outside a display cell, said absorptive polarizer is a dye series polarizer or an E-type polarizer and said reflective polarizer is a reflective type polarized brightness-enhancing film or a cholesterol liquid crystal reflective-type polarizer brightness-enhancing film.

37. The brightness-enhancing integral polarizer and optical film structure of claim 36, wherein if said absorptive polarizer is an E-type polarizer and said reflective polarizer is a cholesterol liquid crystal reflective-type polarizer brightness-enhancing film, λ/4 wavelength sheet is installed between said E-type polarizer and a cholesterol liquid crystal layer.

38. The brightness-enhancing integral polarizer and optical film structure of claim 36, wherein if said absorptive polarizer is an E-type polarizer and said reflective polarizer is a cholesterol liquid crystal reflective-type polarizer brightness-enhancing film, said brightness-enhancing integral polarizer and optical film has a polarization of over about 70% and a light transmission level of over about 40%.

39. The brightness-enhancing integral polarizer and optical film structure of claim 34, further comprising a conductive layer.

40. The brightness-enhancing integral polarizer and optical film structure of claim 39, wherein said conductive layer is constructed on said substrate, said absorptive polarizer, or said reflective polarizer.

41. The brightness-enhancing integral polarizer and optical film structure of claim 34, wherein said brightness-enhancing integral polarizer and optical film is coated to produce a different assembly.

42. The brightness-enhancing integral polarizer and optical film structure of claim 34, wherein said reflective polarizer is constructed inside or outside a display cell.

43. The brightness-enhancing integral polarizer and optical film structure of claim 42, wherein if said reflective polarizer is constructed outside said display cell, said reflective polarizer is a reflective-type polarized brightness-enhancing film or a cholesterol liquid crystal reflective-type polarizer brightness-enhancing film.

44. The brightness-enhancing integral polarizer and optical film structure of claim 34, wherein said absorptive polarizer is constructed inside or outside a display cell.

45. The brightness-enhancing integral polarizer and optical film structure of claim 44, wherein said reflective polarizer is attached onto said absorptive polarizer when being constructed outside said display cell.

46. The brightness-enhancing integral polarizer and optical film structure of claim 44, wherein said absorptive polarizer is coated onto said reflective polarizer first and then attached onto said display cell.

47. The brightness-enhancing integral polarizer and optical film structure of claim 34, wherein said brightness-enhancing integral polarizer and optical film is used as a polarizer of a display, a brightness-enhancing film, a wide viewing angle film or a general optical film.

48. A display unit employing brightness-enhancing integral polarizer and optical film structure, comprising:
an upper substrate and a lower substrate;
at least one brightness-enhancing integral polarizer and optical film, made of a material different from materials of said substrates and installed on a side of said upper substrate or said lower substrate, wherein said material of said brightness-enhancing integral polarizer and optical film include two portions, one being a reflective polarizer and another being an absorptive polarizer; and
a plurality of fluid media, being filled between said upper substrate and said lower substrate.

49. The display unit employing brightness-enhancing integral polarizer and optical film structure of claim 48, wherein said upper and lower substrates are made of a transmissive material or a non-transmissive material.

50. The display unit employing brightness-enhancing integral polarizer and optical film structure of claim 48, wherein if said brightness-enhancing integral polarizer and optical film is constructed outside a display cell, said absorptive polarizer is a dye series polarizer or an E-type polarizer, and said reflective polarizer is a reflective-type polarized brightness-enhancing film or a cholesterol liquid crystal reflective-type polarizer brightness-enhancing film.

51. The display unit employing brightness-enhancing integral polarizer and optical film structure of claim 50, wherein if said absorptive polarizer is an E-type polarizer and said reflective polarizer is a cholesterol liquid crystal reflective-type polarizer brightness-enhancing film, a λ/4 wavelength sheet is installed between said E-type polarizer and a cholesterol liquid crystal layer..

52. The display unit employing brightness-enhancing integral polarizer and optical film structure of claim 50, wherein if said absorptive polarizer is an E-type polarizer and said reflective polarizer is a cholesterol liquid crystal reflective-type polarizer brightness-enhancing film, said brightness-enhancing integral polarizer and optical film has a polarization of over about 70% and a light transmission level of over about 40%.

53. The display unit employing brightness-enhancing integral polarizer and optical film structure of claim 48, wherein said reflective polarizer is constructed inside or outside a display cell.

54. The display unit employing brightness-enhancing integral polarizer and optical film structure of claim 48, wherein if said reflective polarizer is constructed outside a display cell, said reflective polarizer is a reflective type polarized brightness-enhancing film or a cholesterol liquid crystal reflective-type polarizer brightness-enhancing film.

55. The display unit employing brightness-enhancing integral polarizer and optical film structure of claim 48, wherein said absorptive polarizer is constructed inside or outside a display cell.

56. The display unit employing brightness-enhancing integral polarizer and optical film structure of claim 48, wherein said absorptive polarizer is attached to said reflective polarizer when being constructed outside said display cell.

57. The display unit employing brightness-enhancing integral polarizer and optical film structure of claim 48, wherein said absorptive polarizer is coated onto said reflective polarizer first and then attached to said display cell.

58. The display unit employing the brightness-enhancing integral polarizer and optical film structure of claim 48, wherein said display fluid medium is a liquid crystal, an electrophoretic substance, a self-luminous object, or an easily displaying fluid medium.
